(19) United States
(12) Patent Application Publication
(10) Pub. No.: US 2010/0123678 A1
(43) Pub. Date: May 20, 2010

(54) TOUCH INPUT DEVICE AND METHOD OF ACQUIRING CONTACT LOCATION AND INTENSITY OF FORCE USING THE SAME

(75) Inventors: Jong Ho Kim, Daejeon (KR); Yon Kyu Park, Daejeon (KR); Min Seok Kim, Daejeon (KR); Dae Im Kang, Daejeon (KR); Jae-Hyuk Choi, Daejeon (KR)

Correspondence Address: HISCOCK & BARCLAY, LLP, 2000 HSBC PLAZA, 100 Chestnut Street, ROCHESTER, NY, 14604-2404, US

(73) Assignee: Korea Research Institute of Standards and Science, Daejeon (KR)

(21) Appl. No.: 12/351,363

(22) Filed: Jan. 9, 2009

(30) Foreign Application Priority Data
Nov. 14, 2008 (KR) 10-2008-0113117

(51) Int. Cl. G06F 3/045

(52) U.S. Cl. 345/174

(57) ABSTRACT

The present invention relates to a touch input device and a method of acquiring a contact location and the intensity of force using the same. The touch input device may include a touch panel with which a pointing object is brought in contact, a location-processing unit for receiving a signal regarding a contact location from the touch panel and processing information about the contact location of the pointing object, an intensity-processing unit for receiving a signal regarding a change in capacitance between an upper electrode layer of the touch panel and the pointing object from the touch panel and processing information about an intensity of force of the pointing object, and a switching unit for selectively electrically connecting the location-processing unit and the intensity-processing unit to the touch panel, so that information about the location and the intensity of force, of the pointing object, can be acquired.

### BACKGROUND OF THE INVENTION

1. Field of the Invention

The present invention relates to a touch input device and a method of acquiring a contact location and the intensity of force using the same, and more particularly, to a touch input device and a method of acquiring a contact location and the intensity of force using the same, which is capable of acquiring not only location information of a pointing object, which is brought in contact with a touch panel, but also information about the intensity of force according to the contact without a structural change of a conventional touch panel (for example, a touch screen).

2. Background of the Related Art

A human being forms an interface with electronic/mechanical devices in a variety of applications. Thus, there is a continued interest in an interface, which is more natural and easy to use and can provide information. Among devices forming an interface with a user, touch input devices for applying an operation or location command in a touch manner include a touch screen, which is used in various electronic/communication devices such as an automated teller machine in the bank, personal digital assistants, and mobile phones, a touch pad used in a notebook computer, and so on.

A touch panel used in a conventional touch input device, in particular, a contact resistance type touch panel is used as only on/off states because it cannot obtain consecutive data in proportion to force generated by contact using a pointing object (for example, a stylus tip and a finger) due to its great brittleness. That is, the conventional touch panel detects only a contact location by recognizing whether a contact is made. Further, a capacitive type touch panel is problematic in that it is difficult to calculate contact resistance itself. Electronic/communication devices using this touch input device, in particular, communication devices, such as mobile phones having a close relationship with modern persons, have a limit to the full satisfaction of needs for acquiring gradually increasing contact information.

Accordingly, there is a need for the development of a device, which is capable of acquiring information about not only the location of a pointing object, but also the intensity of force according to contact of the pointing object.

### SUMMARY OF THE INVENTION

Accordingly, the present invention has been made in view of the above problems occurring in the prior art, and an object of the present invention is to provide a touch input device and a method of acquiring a contact location and the intensity of force using the same, which is capable of acquiring a contact location of a pointing object, which is brought in contact with a touch panel, in particular, a touch screen, and the intensity of force according to the contact.

Another object of the present invention is to provide a touch input device and a method of acquiring a contact location and the intensity of force using the same, which is capable of acquiring a location with which a pointing object is brought in contact and the intensity of force according to the contact without a structural change of a touch panel.

To achieve the above objects, a touch input device according to the present invention may include a touch panel with which a pointing object is brought in contact; a location-processing unit for receiving a signal regarding a contact location from the touch panel and processing information about the contact location of the pointing object; an intensity-processing unit for receiving a signal regarding a change in capacitance between an upper electrode layer of the touch panel and the pointing object from the touch panel and processing information about an intensity of force of the pointing object; and a switching unit for selectively electrically connecting the location-processing unit and the intensity-processing unit to the touch panel, so that information about the location and the intensity of force, of the pointing object, can be acquired.

In addition, when the touch panel is a contact resistance type touch panel of an array form, comprising an upper electrode layer having a plurality of upper electrode bands formed therein in parallel, and a lower electrode layer having a plurality of lower electrode bands formed in a direction to cross the upper electrode bands, it is preferable that the touch input device further comprises an auxiliary switching unit for electrically connecting the plurality of upper electrode bands of the upper electrode layer in such a way as to form one electrode, so that information about the location and the intensity of force, of the pointing object, can be acquired.

Also, when the touch panel is a capacitive type touch panel of an array form, comprising an upper electrode layer having a plurality of upper electrode bands formed therein in parallel, and a lower electrode layer having a plurality of lower electrode bands formed in a direction to cross the upper electrode bands, it is preferable that the auxiliary switching unit switches over the upper electrode layer and the lower electrode layer so that the upper electrode layer and the lower electrode layer are electrically connected to each other in order to form one electrode.

Moreover, the touch input device of claim 4, wherein the auxiliary switching unit switches over the upper electrode layer and the lower electrode layer so that the upper electrode layer and the lower electrode layer are electrically connected to each other in order to form one electrode.

Also, the switching unit operates while the pointing object is brought in contact with the touch panel.

In addition, it is preferable that the touch input device further comprises a contact detection unit for periodically determining whether the pointing object is touched on the touch panel.

In this instance, the contact detection unit determines whether the pointing object is brought in contact with the touch panel by detecting a change in capacitance between the touch panel and the pointing object.

In addition, the intensity-processing unit previously stores data regarding intensities of force of the pointing object, which correspond to the change in capacitance.

Moreover, according to another aspect of the present invention, there is provided a method of acquiring a contact location and an intensity of force, the method comprising a step of generating a signal, regarding a location of a pointing object that is touched on a touch panel, using the touch panel; a step of processing information about the contact location of the pointing object based on the signal, regarding the location, using a location-processing unit; a first switching step of switching an electrical connection state between the touch panel and the location-processing unit to an electrical connection state between the touch panel and an intensity-processing unit using a switching unit; a step of changing capacitance between an upper layer electrode layer of the touch panel and the pointing object according to the contact of the pointing object; and a step of processing information about an intensity of contacting force of the pointing object based on the capacitance using the intensity-processing unit, so that information about the location and the intensity of force, of the pointing object, can be acquired.

Also, before the step of generating the signal regarding the location, the present invention can further comprise the step of determining whether the pointing object has been touched on the touch panel.

Moreover, according to the present invention, the step of determining whether the pointing object has been touched on the touch panel is performed by detecting the change in capacitance between the upper electrode layer of the touch panel and the pointing object.

In addition, whether the pointing object has been touched on the touch panel is determined based on a threshold value of the capacitance.

Also, the present invention can further comprise a second switching step of switching the electrical connection state between the touch panel and the intensity-processing unit to the electrical connection state between the touch panel and the location-processing unit using the switching unit.

According to the present invention, after the second switching step is performed, the step of generating the signal regarding the location can be performed, so that an execution loop is formed.

According to another aspect of the present invention, there is provided a method of acquiring a contact location and an intensity of force, the method comprising a step of changing capacitance between an upper electrode layer of a touch panel and a pointing object through a contact of the pointing object; a step of processing information about an intensity of contacting force of the pointing object based on the change in capacitance using an intensity-processing unit; a first switching step of switching an electrical connection state between the touch panel and the intensity-processing unit to an electrical connection state between the touch panel and a location-processing unit using a switching unit; a step of generating a signal regarding a location of the pointing object using the touch panel; and a step of processing information about the contact location of the pointing object based on the signal, regarding the location, using the location-processing unit, so that information about the location and the intensity of force, of the pointing object, can be acquired.

In addition, the method of the present invention may further comprise, before the step of changing the capacitance, the step of determining whether the pointing object has been touched on the touch panel.

Moreover, in the present invention, the step of determining whether the pointing object has been touched on the touch panel is performed by detecting the change in capacitance between the upper electrode layer of the touch panel and the pointing object.

According to the present invention, the step of determining whether the pointing object has been touched on the touch panel is performed by determining whether the pointing object has been touched on the touch panel based on a threshold value of the capacitance.

The method of the present invention may further comprise a second switching step of switching the electrical connection state between the touch panel and the location-processing unit to the electrical connection state between the touch panel and the intensity-processing unit using the switching unit.

Also, after the second switching step is performed, the step of changing the capacitance is performed, so an execution loop is formed.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic block diagram showing a touch input device according to the present invention;

FIG. 2 is a lateral view of a touch panel according to the present invention when the touch panel is a contact resistance type;

FIGS. 3A and 3B are exploded perspective views of the touch panel according to the present invention when the touch panel is a contact resistance type;

FIG. 4 is an exploded perspective view of the touch panel according to the present invention when the touch panel is a contact resistance type of an array form;

FIG. 5 is a lateral view of a touch panel according to the present invention when the touch panel is a capacitive type;

FIG. 6 is an exploded perspective view of the touch panel according to the present invention when the touch panel is a capacitive type;

FIG. 7 is a graph showing a relationship between varying capacitance values and the intensity of force as an example of a method of acquiring the intensity of force according to the present invention;

FIG. 8 is a conceptual view schematically showing a method of driving the touch input device according to the present invention; and

FIGS. 9 and 10 are flowcharts showing a method of driving the touch input device according to the present invention.

### DETAILED DESCRIPTION OF THE PREFERRED EMBODIMENT

Hereinafter, the present invention will be described in detail in connection with preferred embodiments with reference to the accompanying drawings. Prior to describing the present invention, a detailed description of pertinent known functions and constructions will be omitted if they are deemed to make the gist of the present invention unnecessarily vague.

<Construction>

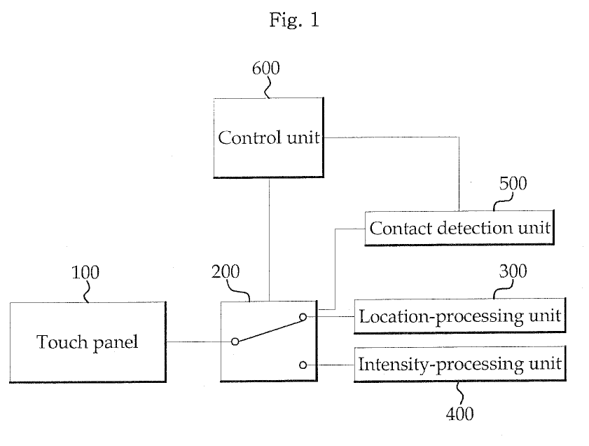

FIG. 1 is a schematic block diagram showing a touch input device according to the present invention. The touch input device according to the present invention includes, as shown in FIG. 1, a touch panel 100, a switch 200, a location-processing unit 300, an intensity-processing unit 400 and the like.

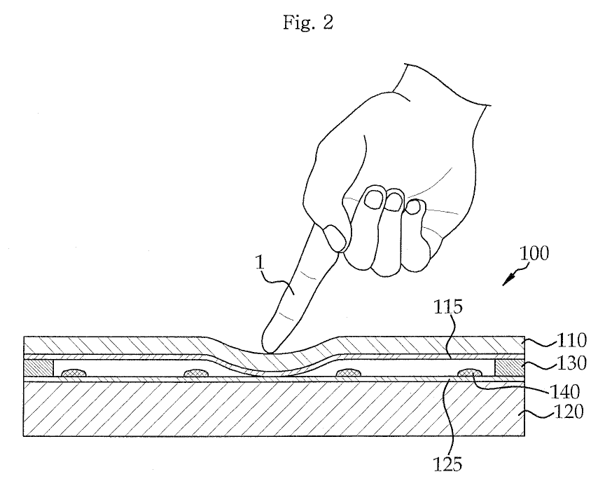

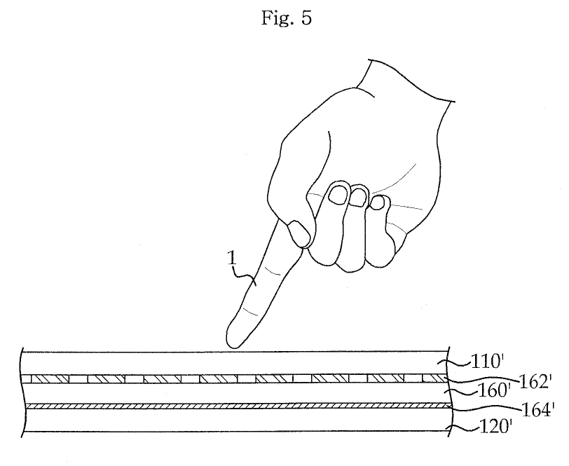

The touch panel 100 is a member with which a pointing object 1 (a stylus tip or a finger) is brought in contact, and may be applied with a location or operation command through a contact with the pointing object 1. The touch panel 100 may employ a touch screen. The touch panel 100 according to the present invention may include a contact resistance type touch panel having a construction as shown in FIG. 2, a contact resistance type touch panel of an array form, a capacitive type touch panel of an array form as shown in FIG. 5, and so on. The contact resistance type touch panel may adopt all kinds of electrode wiring states, such as a four-wiring method or a five-wiring method.

The contact resistance type touch panel includes, as shown in FIG. 2, an upper layer 110 in which a transparent conductive film 115 is formed and a lower layer 120 in which a transparent conductive film 125 is formed. The lower layer 120 is spaced apart from the upper layer 110 at a specific interval, and is configured to include a plurality of dot spacers 140.

The capacitive type touch panel of an array form includes, as shown in FIG. 5, an upper electrode layer having a plurality of upper electrode bands 162′ formed over a central layer 160′ (for example, glass) and a lower electrode layer having a plurality of lower electrode bands 164′ formed under the central layer 160′. The plurality of upper electrode bands 162′ is arranged in parallel, and the plurality of lower electrode bands 164′ is formed to cross the upper electrode bands 162′. Further, an upper layer 110′ with which the pointing object 1 is brought in contact is formed on the upper side of the upper electrode layer, and a lower layer 120′ is formed on the lower side of the lower electrode layer. The upper and lower electrode bands 162′ and 164′ may include transparent electrodes made of ITO.

The touch panel 100 is adapted to acquire information about the intensity of force of the pointing object 1 as well as information about the location of the pointing object 1, which is acquired using a contact resistance type or capacitive type touch panel. Information about the intensity of force of the pointing object 1 is based on a change in capacitance between the upper electrode layer of the touch panel 100 and the pointing object 1. Structures for detecting a change in capacitance are described below according to the above-described types of the touch panel 100.

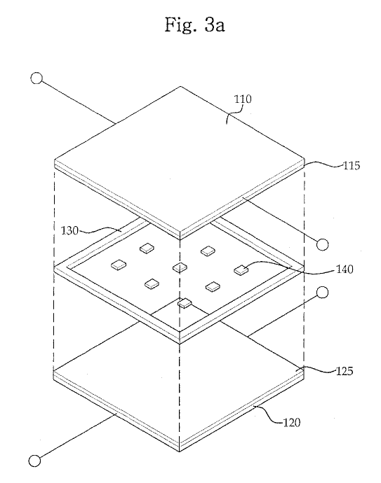

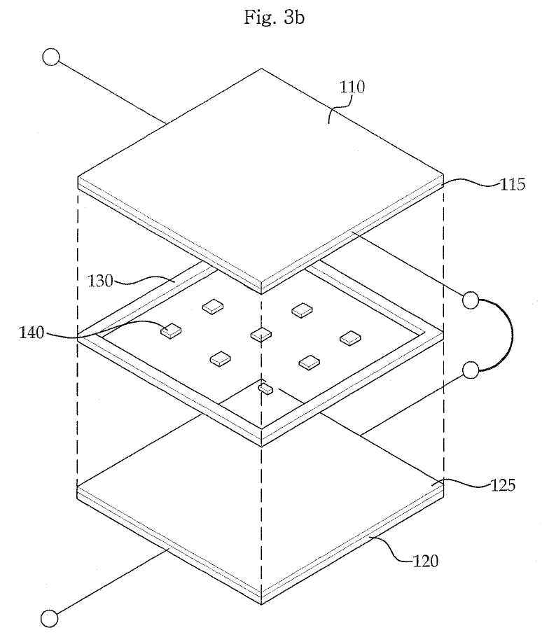

FIGS. 3A and 3B are perspective views showing the upper layer 110 and the lower layer 120 of the contact resistance type touch panel. An upper electrode layer formed in the upper layer 110, that is, the transparent conductive film 115 functions as one electrode, and may be used to detect a change in capacitance between the upper layer 110 of the touch panel 100 and the pointing object 1. Further, as shown in FIG. 3B, a lower electrode layer formed in the lower layer 120, that is, the transparent conductive film 125 and the transparent conductive film 115 formed in the upper layer 110 may be electrically connected to each other in order to form one electrode. That is, if the transparent conductive film 115, that is, the upper electrode layer and the transparent conductive film 125, that is, the lower electrode layer are connected to each other, they electrically function as one electrode, so that a change in capacitance can be detected like FIG. 3A, showing the case in which a change in capacitance between the upper electrode layer and the pointing object 1 is detected.

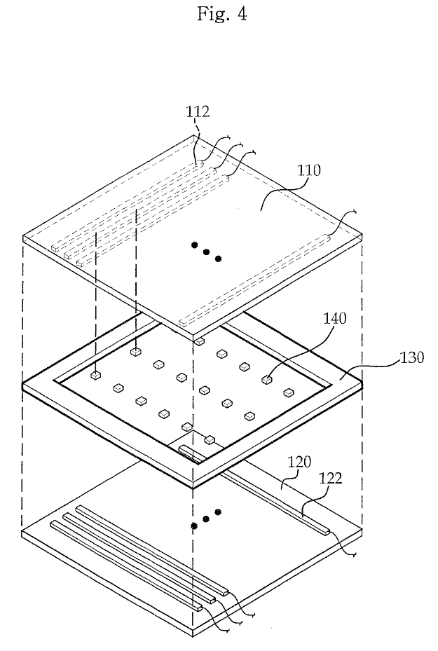

FIG. 4 is a perspective view showing an upper layer 110, an upper electrode layer, a lower layer 120, and a lower electrode layer of a contact resistance type touch panel of an array form. The contact resistance type touch panel of an array form includes the upper electrode layer and the lower electrode layer including a plurality of electrode bands 112 and 122, respectively. The plurality of upper electrode bands 112, that is, the upper electrode layer and the plurality of lower electrode bands 122, that is, the lower electrode layer are disposed to cross each other. In order to detect a change in capacitance between the pointing object 1 and the upper electrode layer, an auxiliary switching unit (not shown) for electrically connecting the plurality of upper electrode bands 112 so that the upper electrode bands 112 function as one electrode is further included.

Further, even in the contact resistance type touch panel of an array form, the upper electrode layer and the lower electrode layer may be electrically connected to each other so that they function as one electrode, in the same manner as the description given with reference to FIG. 3B. The construction in which the upper electrode layer and the lower electrode layer are electrically connected to each other so that they function as one electrode may employ an auxiliary switching unit. If the plurality of lower electrode bands 122 and the plurality of upper electrode bands 112 are electrically connected to each other, the upper electrode bands 112 and the lower electrode bands 122 electrically function as one electrode although they are spaced apart from each other in terms of the structure. Accordingly, it is to be understood that a change in capacitance can be detected event through such electrical connection.

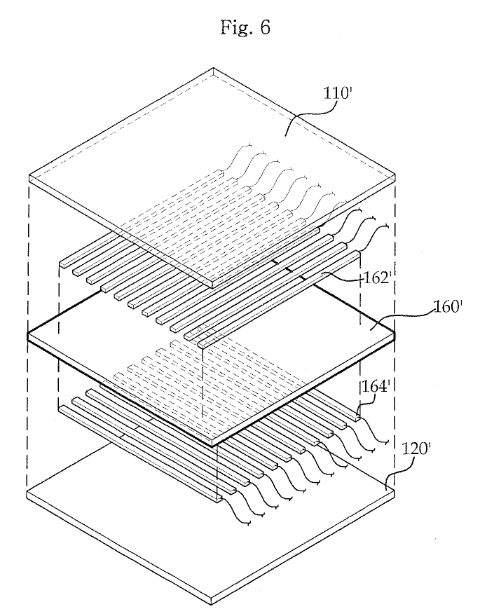

FIG. 6 is a perspective view showing an upper layer 110′, an upper electrode layer, a middle layer 160′, a lower layer 120′, and a lower electrode layer of a capacitive type touch panel of an array form. A plurality of upper electrode bands 162′, that is, the upper electrode layer and a plurality of lower electrode bands 164′, that is, the lower electrode layer, which are disposed over and under the middle layer 160′, respectively, are disposed to cross each other. The plurality of upper electrode bands 162′ and the lower electrode bands 164′ detect capacitance at the intersections, thereby acquiring a contact location. In order to detect a change in capacitance between the pointing object 1 and the upper electrode layer, an auxiliary switching unit for electrically connecting the plurality of upper electrode bands 162′, that is, the upper electrode layer so that they function as one electrode may be further added. Further, even in the capacitive type touch panel of an array form using the auxiliary switching unit, the upper electrode layer and the lower electrode layer may be electrically connected to each other so that they function as one electrode. This fact is identical to the contact resistance type touch panel of an array form and, therefore, a reference can be made to the above description of the contact resistance type touch panel of an array form.

The switching unit 200 is a member for electrically connecting each of the location-processing unit 300 and the intensity-processing unit 400 to the touch panel 100. The switching unit 200 is disposed between the location-processing unit 300 and the intensity-processing unit 400, and selectively connects the location-processing unit 300 and the intensity-processing unit 400 to the touch panel 100. It is preferred that such an operation of the switching unit 200 be performed when the pointing object 1 is brought in contact with the touch panel 100.

The location-processing unit 300 acquires information about a contact location of the pointing object 1, which is brought in contact with the touch panel 100. For example, when the touch panel 100 and the location-processing unit 300 are electrically connected to each other by the switching unit 200, information about a contact location of the pointing object 1 is acquired as a coordinate value. Coordinates can be expressed through a variety of coordinate systems and, for example, an orthogonal coordinate system (x-y coordinate) may be used.

A contact detection unit 500 determines whether the pointing object 1 is touched on the touch panel 100. Since the contact detection unit 500 is further added, malfunction attributable to a contact, which is not related to the intention of a user, (for example, when a finger goes past by the touch panel 100), can be prevented. It is preferred that, only when the contact detection unit 500 detects a contact of the pointing object, a control unit 600 drive the location-processing unit 300 and the intensity-processing unit 400 to be described later. Determination on whether the contact detection unit 500 is touched on the touch panel 100 may employ, for example, a method of detecting a change in capacitance between the upper layer 110 of the touch panel 100 and the pointing object 1.

In addition, determination on a contact of the contact detection unit 500, which is not related to the intention of a user, may be performed by deciding a threshold value of capacitance. For example, it may be considered that a change in capacitance, which does not reach the set threshold value, is a contact not related to the intention of a user, and a change in capacitance, which exceeds the set threshold value, is a contact through which the touch input device is substantially driven.

The intensity-processing unit 400 acquires the intensity of force of the pointing object 1 that is brought in contact with the touch panel 100. In the case in which the touch panel 100 and the intensity-processing unit 400 are electrically connected to each other by the switching unit 200, the intensity-processing unit 400 acquires the intensity of force based on a signal regarding the intensity of force, which is generated from the touch panel 100, that is, a change in capacitance between the upper electrode layer of the touch panel 100 and the pointing object 1. Capacitance between a finger and the upper electrode layer varies depending on a contact area of the pointing object 1, which is brought in contact with the touch panel 100, that is, the finger. For example, when strong force is applied using a finger, a contact area of the finger that is brought in contact with the touch panel 100 increases, resulting in a great change in capacitance. This acquisition of the intensity of force depending on a change in capacitance may be performed through an operation or by searching for pre-stored data values (for example, a look-up table). Alternatively, such acquisition may be performed using both an operation and search for data values.

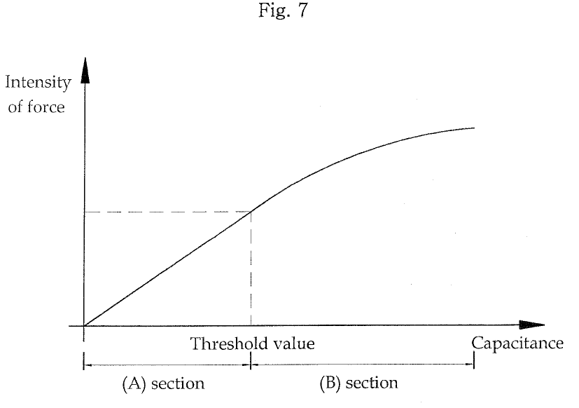

For example, referring to FIG. 7, in a section (A) in which the intensity of force increases in proportion to a change in capacitance, the intensity of force can be calculated accurately, but, in a section (B) in which the intensity of force does not increase in proportion to a change in capacitance, the intensity of force can be acquired by searching for data values. The data values are data regarding intensity values of force, corresponding to varying capacitance values, and are previously stored in the intensity-processing unit. The device of the present invention is configured to immediately process the intensity of force when a varying capacitance value is detected, thereby being capable of making fast a response speed. Here, the data regarding the intensity values of force, corresponding to the varying capacitance values, may be stored using a method such as a look-up table.

As described above, the contact detection unit 500 and the intensity-processing unit 400 are based on a change in capacitance. More preferably, the pointing object 1 may be a finger.

<Method of Acquiring Contact Location and the Intensity of Force>

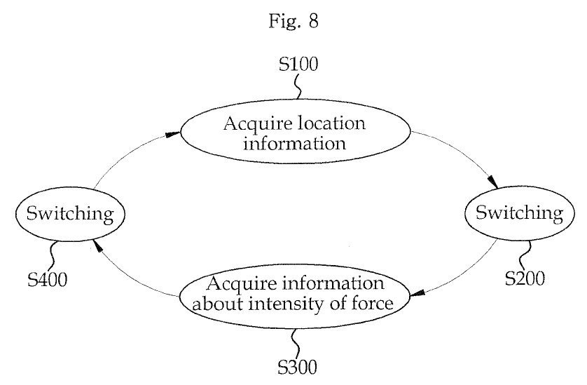

FIG. 8 is a conceptual view schematically showing a method of acquiring a contact location and the intensity of force using the touch input device according to the present invention. The method of acquiring a contact location and the intensity of force according to the present invention has, as shown in FIG. 8, a structure in which acquisition of location information and acquisition of intensity information of force are circulated and a switching step is included between the circulation processes. A method of driving the touch input device according to the present invention may be performed using a circulation method beginning with the acquisition of location information or a circulation method beginning with the acquisition of the intensity information of force.

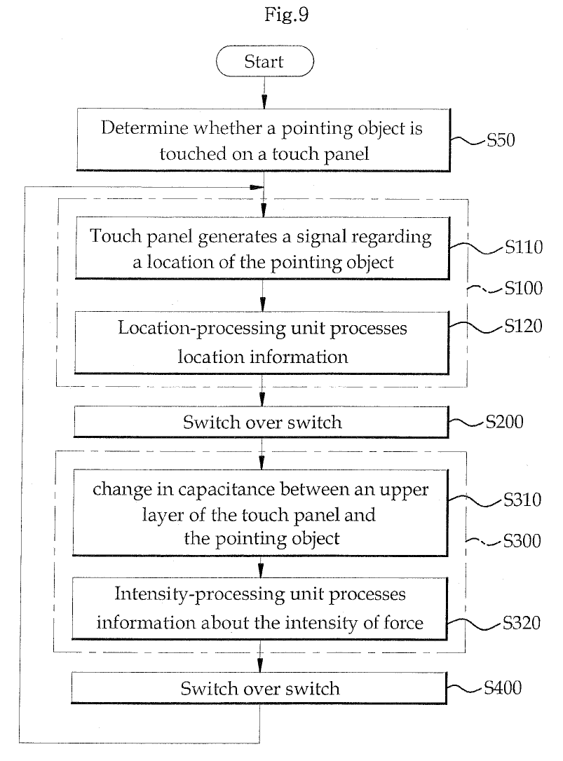

First, FIG. 9 is a flowchart showing a method of acquiring a contact location and the intensity of force, which is performed starting with the acquisition of location information.

A process S100 of acquiring location information is first described below. The acquisition of location information is performed in the state in which the touch panel 100 and the location-processing unit 300 are electrically connected by the switching unit 200. In this state, if the pointing object 1 is touched on the touch panel 100, a signal regarding a contact location of the pointing object 1 is generated (S110). The signal regarding the contact location is applied to the location-processing unit 300. The location-processing unit 300 processes information about the contact location of the pointing object 1 (S120). The information of the contact location may be expressed in, for example, x, y values using an orthogonal coordinate system.

For example, in the case in which a contact resistance type touch panel is used, the process (S120) of processing the information of the contact location using the location-processing unit 300 is described below in detail. Uniform fields parallel to a y-axis direction are distributed on the transparent conductive film 125 of the lower layer 120 of the touch panel 100 (S121). Potential at a specific location, pressed by the pointing object 1, is transferred to the upper layer 110 through a contact resistor (not shown) provided between the upper layer 110 and the lower layer 120 (S122). The potential is applied to the location-processing unit 300 through the wiring lines (not shown), which are configured to detect a location and formed in the upper layer 110, so that x-axis coordinates of the pointing object can be obtained (S123). After the x-axis coordinates are acquired, uniform fields parallel to an x-axis direction are distributed on the transparent conductive film 125 of the lower layer 120 (S125). The potential at the specific location pressed by the pointing object 1 is transferred to the upper layer through the contact resistor provided between the upper layer 110 and the lower layer 120 (S126), so that y-axis coordinates can be obtained (S127).

Next, the switching unit 200 switches to electrically connect the touch panel 100 and the intensity-processing unit 400 (S200) (a first switching step).

A process (S300) of acquiring information about the intensity of force is described below. In the state in which the touch panel 100 and the intensity-processing unit 400 are electrically connected to each other, capacitance between the upper electrode layer of the touch panel 100 and the pointing object 1 is changed depending on a contact of the pointing object 1 (S310). In this case, when a touch panel is, in particular, a contact resistance type of an array form or a capacitive type of an array form, the auxiliary switching unit may be of course operated in order to construct the upper electrode bands 112 and 162′ as one electrode.

Although the upper layer 110 is brought in contact with the lower layer 120, there is no problem in obtaining a change in capacitance between the upper layer 110 of the touch panel 100 and the pointing object 1. Next, the signal regarding the change in capacitance is applied to the intensity detection unit 400. The intensity-processing unit 400 processes information about the intensity of force according to the contact of the pointing object 1 (S320). As described above, a look-up table, etc. of data, which is associated with the intensity of force corresponding to varying capacitance values, is previously stored in the intensity-processing unit. Thus, the intensity-processing unit 400 may process the information about the intensity of force in such a way as to search for the data of the look-up table. In this case, there is an advantage in that the response speed of the touch input device becomes fast because the time that it takes to acquire the intensity of force can be reduced.

Next, the switching unit 200 switches to electrically connect the touch panel 100 and the location-processing unit 300 (S400) (a second switching step).

More preferably, prior to the step (S100) of acquiring the location information, a process (S50) of determining whether the pointing object 1 is touched on the touch panel 100 may be further included. Whether the pointing object 1 is touched on the touch panel 100 may be performed using a method of detecting a change in capacitance between the upper electrode layer of the touch panel 100 and the pointing object 1. At this time, a threshold value of the capacitance may be set in order to use the value as a criterion for determining whether a contact is made. In other words, if a change in capacitance exceeds the threshold value, it may be determined that there is a contact, and a series of the processes (S100 to S400) of acquiring the location of the pointing object 1 and the intensity of force according to the present invention are performed. However, if a change in capacitance, which is smaller than the threshold value, is detected, it may be determined that there is no contact, so the processes of acquiring the location of the pointing object 1 and the intensity of force are not performed.

It is preferred that the respective processes of acquiring a contact location and the intensity of force according to the present invention constitute one loop and be repeatedly performed.

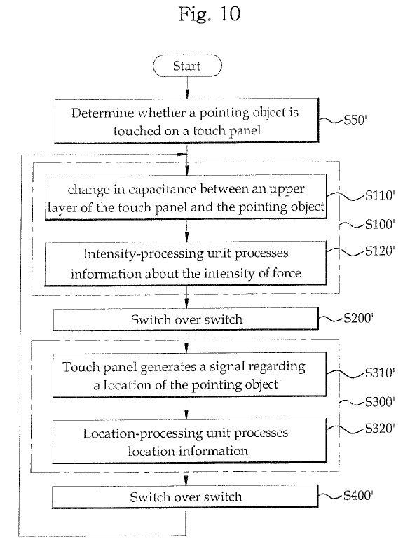

FIG. 10 is a flowchart showing a method of driving the touch input device according to the present invention, which is circulated starting with the process of acquiring the intensity information of force. In the present embodiment, descriptions of a process (S100′) of acquiring intensity information of force and a process (S300′) of acquiring location information are identical to those of the process (S300) of acquiring intensity information of force and the process (S100) of acquiring location information in the acquisition method described with reference to FIG. 9. However, in the present embodiment, the switching direction of the switching unit 200 in a first switching step S200′ corresponds to a direction in which the touch panel 100 and the location-processing unit 300 are electrically connected to each other, and the switching direction of the switching unit 200 in a second switching step S4200′ corresponds to a direction in which the touch panel 100 and the intensity-processing unit 400 are electrically connected.

Even in the present embodiment, prior to the process (S100′) of acquiring intensity information of force, a process (S50′) of determining whether the pointing object 1 is touched on the touch panel 100 may be further added. The processes of acquiring a contact location and the intensity of force according to the present embodiment may form one loop and be repeatedly performed as described above in detail.

The touch input device and the method of acquiring a contact location and the intensity of force using the same according to the present invention may be used in any devices to which an operation command is applied through touch input, such as information communication devices (for example, mobile phones, PMPs, PDAs, and navigators) and game machines. In particular, in the case in which characters are input in a touch manner, the darkness of the characters may be adjusted in proportion to the intensity of force or the shapes of the characters may be changed depending on the intensity of force.

As described above, an embodiment of the present invention is advantageous in that not only a contact location of a pointing object, but also the intensity of force according to the contact may be acquired.

Further, since a conventional touch panel, that is, a touch screen can be used as it is, there is an advantage in that the cost for fabrication of a touch panel may be saved.

In addition, a variety of interfaces may be provided to a user based on location information of a pointing object and information about the intensity of force thereof.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A touch input device, comprising:
a touch panel with which a pointing object is brought in contact;
a location-processing unit for receiving a signal regarding a contact location from the touch panel and processing information about the contact location of the pointing object;
an intensity-processing unit for receiving a signal regarding a change in capacitance between an upper electrode layer of the touch panel and the pointing object from the touch panel and processing information about an intensity of force of the pointing object; and
a switching unit for selectively electrically connecting the location-processing unit and the intensity-processing unit to the touch panel, so that information about the location and the intensity of force, of the pointing object, can be acquired.

2. The touch input apparatus according to claim 1,
the touch panel is a contact resistance type touch panel of an array form, comprising an upper electrode layer having a plurality of upper electrode bands formed therein in parallel, and a lower electrode layer having a plurality of lower electrode bands formed in a direction to cross the upper electrode bands, and
the touch input device further comprises an auxiliary switching unit for electrically connecting the plurality of upper electrode bands of the upper electrode layer in such a way as to form one electrode, so that information about the location and the intensity of force, of the pointing object, can be acquired.

3. The touch input device of claim 2, wherein the auxiliary switching unit switches over the upper electrode layer and the lower electrode layer so that the upper electrode layer and the lower electrode layer are electrically connected to each other in order to form one electrode.

4. The touch input device of claim 1 wherein:
the touch panel is a capacitive type touch panel of an array form, comprising an upper electrode layer having a plurality of upper electrode bands formed therein in parallel, and a lower electrode layer having a plurality of lower electrode bands formed in a direction to cross the upper electrode bands, and
the touch input device further comprises an auxiliary switching unit for electrically connecting the plurality of upper electrode bands of the upper electrode layer in such a way as to form one electrode, so that information about the location and the intensity of force, of the pointing object, can be acquired.

5. The touch input device of claim 4, wherein the auxiliary switching unit switches over the upper electrode layer and the lower electrode layer so that the upper electrode layer and the lower electrode layer are electrically connected to each other in order to form one electrode.

6. The touch input device of claim 1, wherein the switching unit operates while the pointing object is brought in contact with the touch panel.

7. The touch input device of claim 1, further comprising a contact detection unit for periodically determining whether the pointing object is touched on the touch panel.

8. The touch input device of claim 7, wherein the contact detection unit determines whether the pointing object is brought in contact with the touch panel by detecting a change in capacitance between the touch panel and the pointing object.

9. The touch input device of claim 1, wherein the intensity-processing unit previously stores data regarding intensities of force of the pointing object, which correspond to the change in capacitance.

10. A method of acquiring a contact location and an intensity of force, the method comprising:
a step of generating a signal, regarding a location of a pointing object that is touched on a touch panel, using the touch panel;
a step of processing information about the contact location of the pointing object based on the signal, regarding the location, using a location-processing unit;
a first switching step of switching an electrical connection state between the touch panel and the location-processing unit to an electrical connection state between the touch panel and an intensity-processing unit using a switching unit;
a step of changing capacitance between an upper layer electrode layer of the touch panel and the pointing object according to the contact of the pointing object; and
a step of processing information about an intensity of contacting force of the pointing object based on the capacitance using the intensity-processing unit, so that information about the location and the intensity of force, of the pointing object, can be acquired.

11. The method as claimed in claim 10, further comprising, before the step of generating the signal regarding the location, the step of determining whether the pointing object has been touched on the touch panel.

12. The method as claimed in claim 11, wherein the step of determining whether the pointing object has been touched on the touch panel is performed by detecting the change in capacitance between the upper electrode layer of the touch panel and the pointing object.

13. The method as claimed in claim 12, wherein whether the pointing object has been touched on the touch panel is determined based on a threshold value of the capacitance.

14. The method as claimed in claim 10, further comprising a second switching step of switching the electrical connection state between the touch panel and the intensity-processing unit to the electrical connection state between the touch panel and the location-processing unit using the switching unit.

15. The method as claimed in claim 14, wherein, after the second switching step is performed, the step of generating the signal regarding the location is performed, so that an execution loop is formed.

16. The method as claimed in claim 10, wherein:
data regarding intensities of force of the pointing object, which correspond to the change in capacitance, is stored in the intensity-processing unit, and
the step of processing the information about the intensity of force includes processing the information about the intensity of force of the pointing object by searching for the data stored in the intensity-processing unit.

17. A method of acquiring a contact location and an intensity of force, the method comprising:
a step of changing capacitance between an upper electrode layer of a touch panel and a pointing object through a contact of the pointing object;
a step of processing information about an intensity of contacting force of the pointing object based on the change in capacitance using an intensity-processing unit;
a first switching step of switching an electrical connection state between the touch panel and the intensity-processing unit to an electrical connection state between the touch panel and a location-processing unit using a switching unit;
a step of generating a signal regarding a location of the pointing object using the touch panel; and
a step of processing information about the contact location of the pointing object based on the signal, regarding the location, using the location-processing unit, so that information about the location and the intensity of force, of the pointing object, can be acquired.

18. The method as claimed in claim 17, further comprising, before the step of changing the capacitance, the step of determining whether the pointing object has been touched on the touch panel.

19. The method as claimed in claim 18, wherein the step of determining whether the pointing object has been touched on the touch panel is performed by detecting the change in capacitance between the upper electrode layer of the touch panel and the pointing object.

20. The method as claimed in claim 19, wherein the step of determining whether the pointing object has been touched on the touch panel is performed by determining whether the pointing object has been touched on the touch panel based on a threshold value of the capacitance.

21. The method as claimed in claim 17, further comprising a second switching step of switching the electrical connection state between the touch panel and the location-processing unit to the electrical connection state between the touch panel and the intensity-processing unit using the switching unit.

22. The method as claimed in claim 21, wherein, after the second switching step is performed, the step of changing the capacitance is performed, so an execution loop is formed.

23. The method as claimed in claim 17, wherein:
data regarding intensities of force of the pointing object, which correspond to the change in capacitance, is stored in the intensity-processing unit, and
the step of processing the information about the intensity of force includes processing the information about the intensity of force of the pointing object by searching for the data stored in the intensity-processing unit.
wherein the adhesive layer comprises a thermosetting adhesive consisting essentially of acryl, urethane, and phenol resin, and
the metal surface material is any one selected from a stainless steel sheet, a copper plate, or an aluminum plate.
